(19) United States
(12) Patent Application Publication
(10) Pub. No.: US 2015/0251305 A1
(43) Pub. Date: Sep. 10, 2015

(54) Extension wrench/handle

(71) Applicant: Gerald Shane Mulligan, Boise, ID (US)

(72) Inventor: Gerald Shane Mulligan, Boise, ID (US)

(21) Appl. No.: 13/999,059

(22) Filed: Mar. 4, 2014

(51) Int. Cl. B25G 1/00; B25B 23/16

(52) U.S. Cl. CPC B25G 1/005; B25B 23/16

(57) ABSTRACT

This tool is designed to attach to the open end of a wrench, as shown in FIGS. 3 and 4. It locks into place with forward pressure and releases when the pressure is reversed. The tool consists of three parts: the tip that locks onto the open end of a wrench, the shaft that provides the required length of the tool, and the contoured handle where an individual places their hand. The tip of the tool is angled to provide two angle positions for the open end wrench. The angle of the tip can be changed from zero to 90 degrees in order to change those two angles. Depending on the angle of the tip, the tool provides a zero to 90 degree offset to the wrench itself, as shown in FIGS. 3 and 4. This tool is made of steel construction. This tool is designed so that it can attach to special designed attachments designed by us.

### CROSS REFERENCE TO RELATED APPLICATIONS

1. U.S. Pat. No. 1,511,738

This tool locks onto the handle of an open end wrench and has no shaft and handle portion. It does not have a tip and it has 2 side hooks that hold on to the open end wrench. The wrench can slip if forward pressure is applied. This tool cannot be used on a full set of open end wrenches.

2. U.S. Pat. No. 2,725,773

This tool is not used on open end wrenches, so even though it is a cheater bar and adds length, it is not used on the same type of tools as ours.

3. U.S. Pat. No. 4,104,935

This is a tool shown to be used on the shaft portion of a wrench. It does not consist of a tip, a shaft and a handle portion. Its tip is one sided and is shown to be made out of flat steal with screw-in pins that hold the shaft portion of the open end wrench. It shows the open end wrench on an angle and our wrench offers 180 degrees between our extension wrench and the open end wrench. Also, an angle is used between our wrench and the opened end wrench. The open end wrench can slip off this tool because it is one sided. Our wrench offers support on both THE LEFT AND THE RIGHT SIDE of the open end wrench, as well as locks onto the open end of the open end wrench, so, when forward pressure is applied, the two wrenches become solid and cannot slip off of each other. Our wrench provides a contoured handle on which to place your hands during use to provide a firm grip, as well as providing a separate shaft to provide whatever lengths are required to provide as much extra leverage as possible.

4. U.S. Pat. No. 5,535,649

This tool is shown to provide an extended attachment to a pipe wrench instead of an open end wrench.

5. U.S. Pat. No. 6,845,692

This is not a complete tool—it has to use another tool as its handle. It is also one sided and the pins are made as one and are screwed onto the tip as a U-bolt, which holds the wrench to the tip by its middle shaft and has to be screwed in and out every time a wrench is installed. It makes the open end wrench that is attached to be at an angle from the attached tip where ours allows the wrench to be 180 degrees with our wrench plus and alternate angle.

### STATEMENT REGARDING FEDERALLY SPONSORED RESEARCH OR DEVELOPMENT.

Not Applicable.

### REFERENCE TO A SEQUENCE LISTING, A TABLE, OR A COMPUTER PROGRAM, LISTING COMPACT DISC APPENDIX

Not applicable.

### BACKGROUND OF THE INVENTION

The tool show in FIG. 1 was created in the field of Mechanics, Aircraft, Auto, Tractor. There has been a lack of a quality type tool of this nature for which this tool provides a solution. Although there are several designs that have been patented in this realm, none have provided the full scope of a completed tool that is safe and effective that can service a full set of open end wrenches as shown in FIG. 4F. Hence, at present, there are no tools of this type found in mainstream stores.

### BRIEF SUMMARY OF THE INVENTION

A tool to provide extra length and a handle in a safe and secure comfortable easy to use manner, to a full set of open end wrenches as shown in FIG. 4F. This tool is of solid construction with no moving or removable parts.

### BRIEF DESCRIPTION OF THE SEVERAL VIEWS OF THE DRAWINGS

FIG. 1—Side view of extension wrench

A. Contoured handle

B. Connecting end

C. Grooved rings for hand gripping

D. Steel locking pin connecting 2 sides of connecting end which lock onto open end of wrench 1 inside and the other out.

E. Steel locking pin

F. Round shaft connecting handle to connecting end

G. Grooved rings for hand gripping

H. Tip of connecting end

FIG. 2—Top view of extension wrench

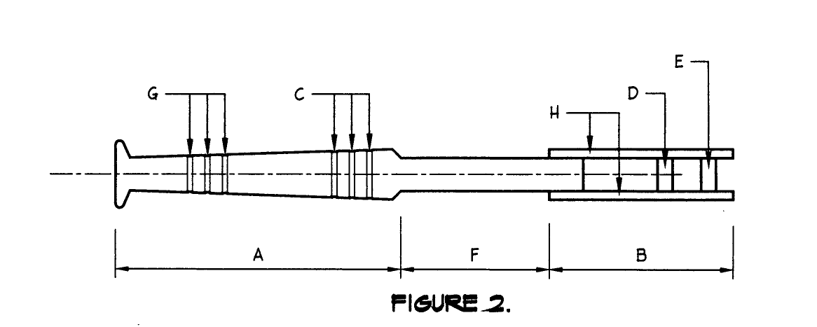

Contoured handle for hand placement

A. Contoured handle for hand placement

B. Connecting end

C. Grooved rings for gripping

D. Steel locking pin

E. Steel locking pin

F. Round connecting shaft

G. Grooved rings for hand gripping

H. Connecting tip end

FIG. 3—Illustrating extension wrench used with Open End Wrench

A. Open end wrench

B. Extension wrench

Illustration of 180 degree connecting angle of open end wrench into connecting end.

FIG. 4—Illustrating extension wrench used with Open End Wrench

A. Open end wrench

B. Extension wrench

Illustration of connecting offset angle of open end wrench inserted into connecting end.

### DETAILED DESCRIPTION OF THE INVENTION

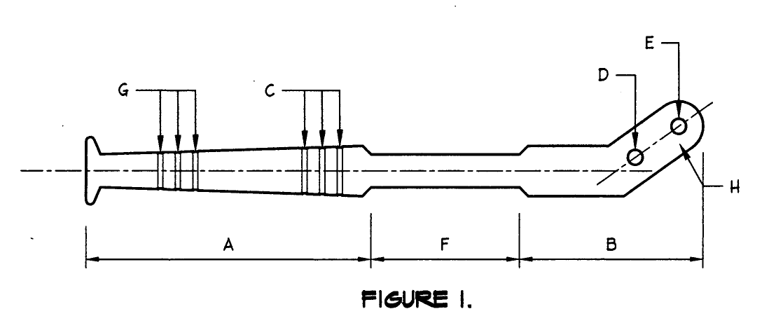

The tool shown in FIG. 1 is manufactured by 2 methods. In the first method, the shaft and handle portion are machined out of steel and the tip is produced in 4 portions—the left side of tip, right side of tip, and the 2 steel pins. Each piece is cut out of steel and welded together, then welded onto the shaft portion of the tool shown in FIG. 1. In the second method, the tool is cast out of steel in a mold as one solid piece construction.

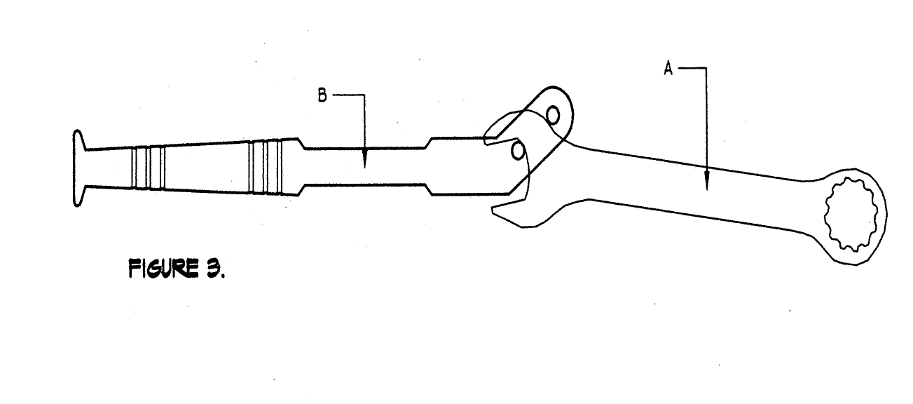

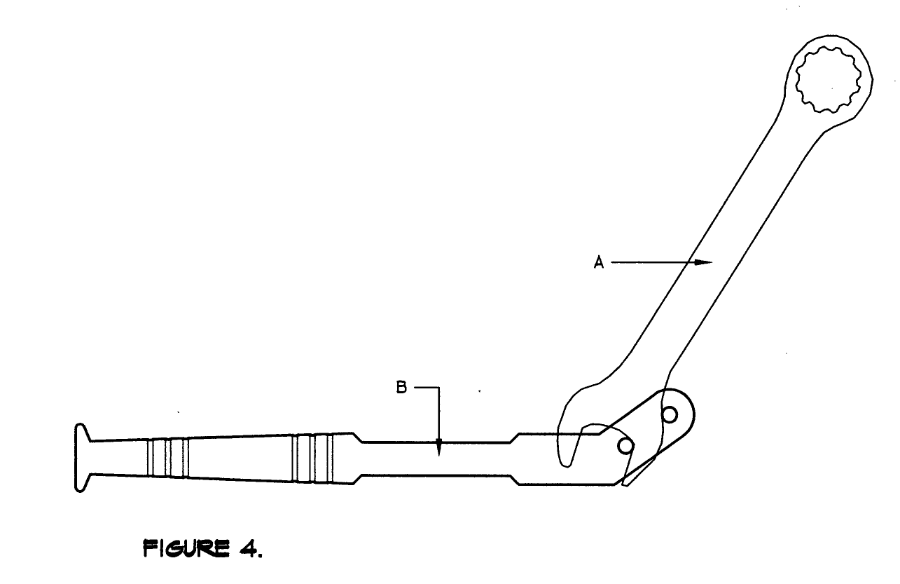

This tool is used by holding the handle portion in your hand and taking the open end portion of an open end wrench and placing the steel pin closest to the shaft portion of the tool in FIG. 1 into the open end of the open end wrench and the pin farthest from the shaft supports the outside of the open end wrench. As seen in FIGS. 3 and 4.

The tool shown in FIG. 1 supports the open end wrench by having a left and a right side with 2 steel pins between the 2 sides so that when pressure is applied to the left and the right, while using the tool shown in FIG. 1, the open end wrench is unable to slip off the tool shown in FIG. 1, nor can the open end wrench slip forward due to the steel pin between 2 sides being inserted into open end portion of open end wrench as shown in FIGS. 3 and 4.

1. The tool show in FIG. 1 provides a tip, shaft, and contoured handle all of single solid construction which the open end portion of an open end wrench, as shown in FIGS. 3 and 4, locks into the tip of FIG. 1 tool and provides solid secure tool-to-tool connection with forward and left to right pressure. The tool in FIG. 1 is designed to not allow the open end wrench to slip off tip when side pressure is applied and forward pressure is applied.

2. The tool shown in FIG. 1 will fit 6 and more sizes of open end wrenches as shown in FIG. 4F.

3. The tool in FIG. 1 provides 2 angles of attachment for each open end wrench as shown in FIGS. 3 and 4.
